(19) United States
(12) Patent Application Publication
(10) Pub. No.: US 2024/0317111 A1
(43) Pub. Date: Sep. 26, 2024

(54) CONTROLLER

(71) Applicant: HONDA MOTOR CO., LTD., Tokyo (JP)

(72) Inventors: Takahiro KOZEKI, Tokyo (JP); Masashi BANDO, Tokyo (JP)

(21) Appl. No.: 18/590,901

(22) Filed: Feb. 28, 2024

(30) Foreign Application Priority Data
Mar. 24, 2023 (CN) 202310299332.3

(51) Int. Cl. B60L 58/26; B60L 58/16

(52) U.S. Cl. CPC B60L 58/26; B60L 58/16; B60L 2240/525; B60L 2240/526; B60L 2240/547; B60L 2240/549

(57) ABSTRACT

An object is to provide a controller that makes it possible to efficiently perform temperature control for an electric power converter that converts electric power supplied from a battery while reflecting a deterioration state of the battery. A controller 10 executes output limitation in accordance with a temperature of a refrigerant that cools a power control unit (PCU) 14 serving as an electric power converter, and changes a temperature serving as a criterion for executing the output limitation, in accordance with a deterioration state of a battery 11. As deterioration in the battery 11 advances, the temperature serving as the criterion for executing the output limitation is lowered.

This application is based on and claims the benefit of priority from Chinese Patent Application No. CN202310299332.3, filed on 24 Mar. 2023, the content of which is incorporated herein by reference.

### BACKGROUND OF THE INVENTION

### Field of the Invention

The present invention relates to a controller.

### Related Art

Conventionally, such a technique has been known that controls electric power of a battery based on a temperature of cooling water. Patent Document 1 describes one type of such technique.

Patent Document 1 describes that a temperature of cooling water is acquired, and, when the temperature of the cooling water has risen excessively, total electric power of a converter and an inverter is reduced in accordance with the temperature to suppress generation of heat. Patent Document 1 also describes that the converter limits electric power.
Patent Document 1: Japanese Unexamined Patent Application, Publication No. 2003-274509

### SUMMARY OF THE INVENTION

Executing power saving for a voltage control unit (VCU) when a temperature of water at an inlet of a power control unit (PCU) serving as an electric power converter that converts electric power is equal to or above a certain value makes it possible to suppress generation of heat. However, if a battery has deteriorated, it may be necessary for a larger electric current to be drawn after power saving has been executed than when the battery was new, leading to the VCU being more likely to overheat. In this case, it may be necessary to further execute power saving, possibly requiring a larger PCU and a larger VCU in chip size. There is a need for improvements in the conventional technique in terms of temperature control in which deterioration of a battery is taken into account.

An object of the present invention is to provide a controller that makes it possible to efficiently perform temperature control for an electric power converter that converts electric power supplied from a battery while reflecting a deterioration state of the battery.

(1) The present invention relates to a controller that executes output limitation in accordance with a temperature of a refrigerant that cools an electric power converter, and changes a temperature serving as a criterion for executing the output limitation, in accordance with a deterioration state of a battery.

According to the invention described in (1), a temperature serving as a criterion for executing output limitation is set in accordance with a deterioration state, allowing the electric power converter to be cooled to an appropriate temperature even when the battery is deteriorated and an electric current flows at a large amount while power saving is executed.

(2) The controller described in (1), in which, as deterioration in the battery advances, the temperature serving as the criterion for executing the output limitation is lowered.

According to the invention described in (2), a temperature at which output limitation is executed while reflecting a degree of deterioration is set, making it possible to achieve more appropriate temperature control.

(3) The controller described in (1), in which, based on whether or not power saving is executed for the battery, the temperature serving as the criterion for executing the output limitation is lowered.

According to the invention described in (3), there is less necessity to execute output limitation on a side of the electric power converter when power saving is executed for the battery serving as an output supply source, making it possible to achieve more efficient temperature control in accordance with a situation.

(4) The controller described in (1) or (2), in which the deterioration state of the battery is determined based on internal resistance of the battery.

According to the invention described in (4), it is possible to accurately set a temperature at which output limitation should be executed, based on internal resistance that may cause an electric current to increase, which leads to a problem in temperature.

(5) The controller described in (4), in which the internal resistance is calculated based on voltages and electric currents inputted into and outputted from the battery.

According to the invention described in (5), it is possible to calculate internal resistance without adding complicated control or a complicated configuration.

(6) The controller described in any one of (1) to (3), in which, when a grille shutter mounted on a vehicle is in a closed state, the temperature serving as the criterion for executing the output limitation is lowered.

According to the invention described in (6), it is possible to achieve more accurate temperature control reflected with transient responsiveness of a temperature of the refrigerant, which changes in accordance with an opened state or the closed state of the grille shutter.

(7) The controller described in any one of (1) to (3), in which, a heat exchanger that exchanges heat with a refrigerant for a driver is disposed in a cooling circuit, in which the refrigerant flows, for the electric power converter, and while heat is exchanged by the heat exchanger, the temperature serving as the criterion for executing the output limitation is lowered.

According to the invention described in (7), it is possible to achieve more accurate temperature control reflected with a change in temperature of the refrigerant, which fluctuates depending on whether or not heat is exchanged with the heat exchanger.

According to the present invention, it is possible to provide a controller that makes it possible to efficiently perform temperature control for an electric power converter that converts electric power supplied from a battery while reflecting a deterioration state of the battery.

### BRIEF DESCRIPTION OF THE DRAWINGS

FIG. 1 is a functional block diagram illustrating a configuration of a battery system to which a controller according to an embodiment of the present invention is applied;

FIG. 2 is a graph illustrating an output (electric power) that changes along with deterioration of a battery;

FIG. 3 is a view illustrating a common battery model;

FIG. 4 is a graph illustrating a relationship between resistance and an electric current that change along with deterioration of the battery;

FIG. 5 is a graph illustrating a relationship between a deterioration state and a limitation-starting temperature for a voltage control unit (VCU), according to the present embodiment;

FIG. 6 is a flowchart illustrating a flow of processing of first VCU control performed by the controller according to the present embodiment;

FIG. 7 is a flowchart illustrating a flow of processing of second VCU control performed by the controller according to the present embodiment;

FIG. 8 is a flowchart illustrating a flow of processing of third VCU control performed by the controller according to the present embodiment;

FIG. 9 is a graph illustrating an example of a map for determining a limitation-starting temperature for the VCU based on a deterioration state under the third VCU control;

FIG. 10 is a graph illustrating an example of maps for determining a limitation-starting temperature for the VCU based on a deterioration state under fourth VCU control;

FIG. 11 is a flowchart illustrating a flow of processing of the fourth VCU control performed by the controller according to the present embodiment;

FIG. 12 is a functional block diagram illustrating a configuration of a battery system to which a controller according to a modification example is applied;

FIG. 13 is a view illustrating an opened state and a closed state of a grille shutter;

FIG. 14 is a graph illustrating an example of maps for determining a limitation-starting temperature for the VCU based on a deterioration state, according to the modification example;

FIG. 15 is a functional block diagram illustrating a configuration of a battery system to which a controller according to another modification example is applied; and

FIG. 16 is a view illustrating a relationship between an opened state and a closed state of a flow shut-off valve and an amount of cooling water.

### DETAILED DESCRIPTION OF THE INVENTION

An embodiment of the present invention will now be described herein with reference to the accompanying drawings.

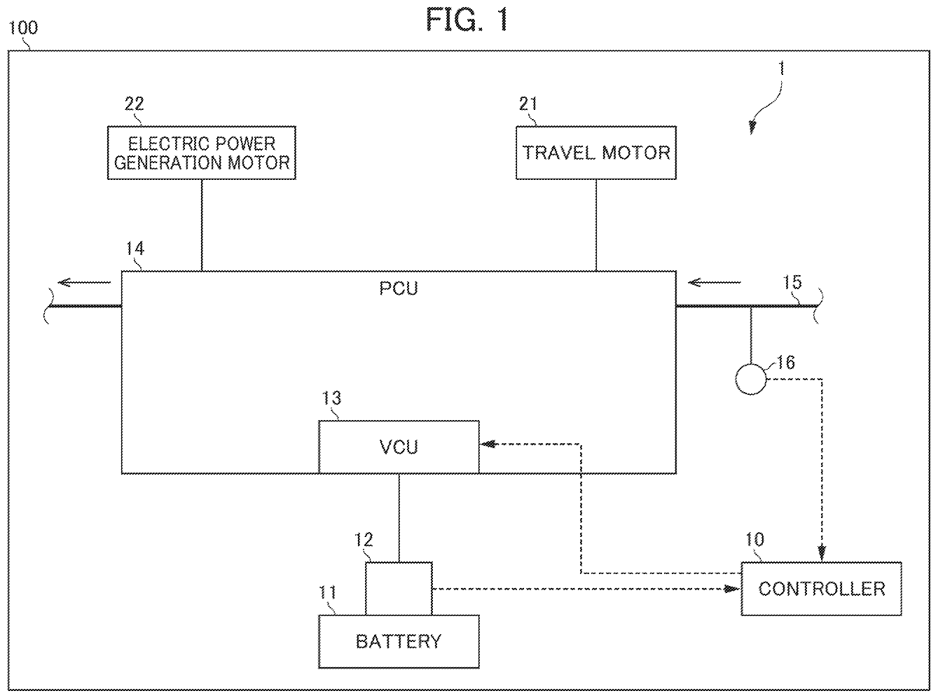

FIG. 1 is a functional block diagram illustrating a configuration of a battery system 1 to which a controller 10 according to the embodiment of the present invention is applied. The battery system 1 illustrated in FIG. 1 is applied to a vehicle 100. The vehicle 100 according to the present embodiment is a hybrid electric vehicle (HEV) having a two-motor drive system including a travel motor 21 and an electric power generation motor 22. Note that the vehicle 100 to which the battery system 1 is applied is not limited to a hybrid electric vehicle having a two-motor drive system, but is able to be applied to a vehicle applied with another style such as an electric vehicle provided only with a travel motor or a facility in which a battery is used.

As illustrated in FIG. 1, the battery system 1 includes a battery 11, a battery sensor 12, a voltage control unit (VCU) 13, a power control unit (PCU) 14, and the controller 10.

The battery 11 is, for example, a secondary battery such as a lithium ion battery. A battery style applied to the battery 11 is not particularly limited.

The battery sensor 12 is a detector that detects voltages and electric currents inputted into and outputted from the battery 11. Information indicating an electric current and a voltage that the battery sensor 12 has detected is transmitted to the controller 10.

The VCU 13 is a voltage controller that controls electric power supplied to the PCU 14. The VCU 13 is, for example, a direct current-direct current (DC-DC) converter that raises and outputs a voltage of electric power supplied from the battery 11.

The PCU 14 is, for example, an electric power converter that performs alternating current-direct current (AC-DC) conversion. The PCU 14 is coupled to the battery 11 via the VCU 13. The PCU 14 converts a direct current supplied from the battery 11 via the VCU 13 into an alternating current, supplies the converted alternating current to the travel motor 21, converts an alternating current generated by the travel motor 21 into a direct current, and transmits the converted direct current to a side of the battery 11. Furthermore, the PCU 14 converts an alternating current generated by the electric power generation motor 22 into a direct current, transmits the converted direct current to the side of the battery 11, converts a direct current supplied from the battery 11 via the VCU 13 into an alternating current, and supplies the converted alternating current to the electric power generation motor 22.

A cooling circuit 15 that cools the PCU 14 is coupled to the PCU 14 according to the present embodiment. Through the cooling circuit 15, a refrigerant (for example, cooling water) is supplied to the PCU 14. The refrigerant supplied to the PCU 14 exchanges heat with the PCU 14, and then circulates in the cooling circuit 15. The cooling circuit 15 is disposed with a temperature sensor 16 that detects a temperature of the water at an inlet of the PCU 14. The temperature of the water at the inlet of the PCU 14 detected by the temperature sensor 16 is transmitted to the controller 10. It is possible to appropriately change a location at which the temperature sensor 16 is disposed, as long as it is possible to detect a temperature of the water at the inlet of the PCU 14.

The controller 10 is a computer that executes various types of control for the battery system 1. The controller 10 includes, for example, a processor, a main storage device including a read only memory (ROM) and a random access memory (RAM), and an auxiliary storage device such as a storage. Note that the controller 10 may include a single computer or a plurality of computers. A location at which the controller 10 is disposed is not particularly limited.

The controller 10 according to the present embodiment performs such control that, when a temperature of the water at the inlet of the PCU 14 is equal to or above a value that is set beforehand, power saving is executed for the VCU 13 to execute output limitation to change a water-temperature threshold value serving as a criterion for determining whether or not power saving is to be executed for the VCU 13 in accordance with a deterioration state of the battery 11.

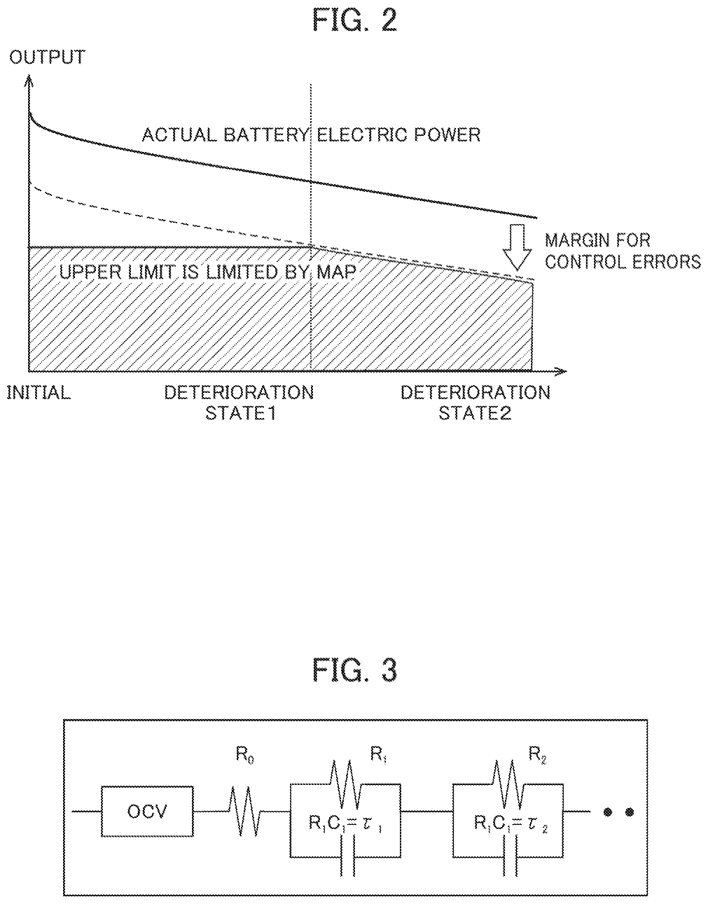

Deterioration of the battery 11 will now be described herein. FIG. 2 is a graph illustrating an output (electric power) that changes along with deterioration of the battery 11. In the example illustrated in FIG. 2, a period of time within which a certain output of the battery 11 is guaranteed is set in a battery deterioration state 1, and an available period of time as a battery even with a lowered output is set in a battery deterioration state 2. As illustrated in FIG. 2, an actual battery voltage lowers in general as time passes from an initial state (beginning of life (BOL)). An upper limit value for an output is set in a map that is set based on a margin for control errors and a period of time within which an output is guaranteed, and power saving is executed for the VCU 13 based on the upper limit value.

FIG. 3 is a view illustrating a common battery model. Equation (1) described below is an electric power calculating equation. In Equation (1), OCV indicates an open circuit voltage. As illustrated in FIG. 3 and Equation (1), it is necessary to allow an electric current to flow at a large amount to keep an output P as cell resistance R increases.

$$\begin{matrix}[ Mathematical Equation 1 ] & \\ P = {V}_{limit} \times \frac{( {V}_{limit} - OCV )}{Cell R} & Equation ( 1 )\end{matrix}$$

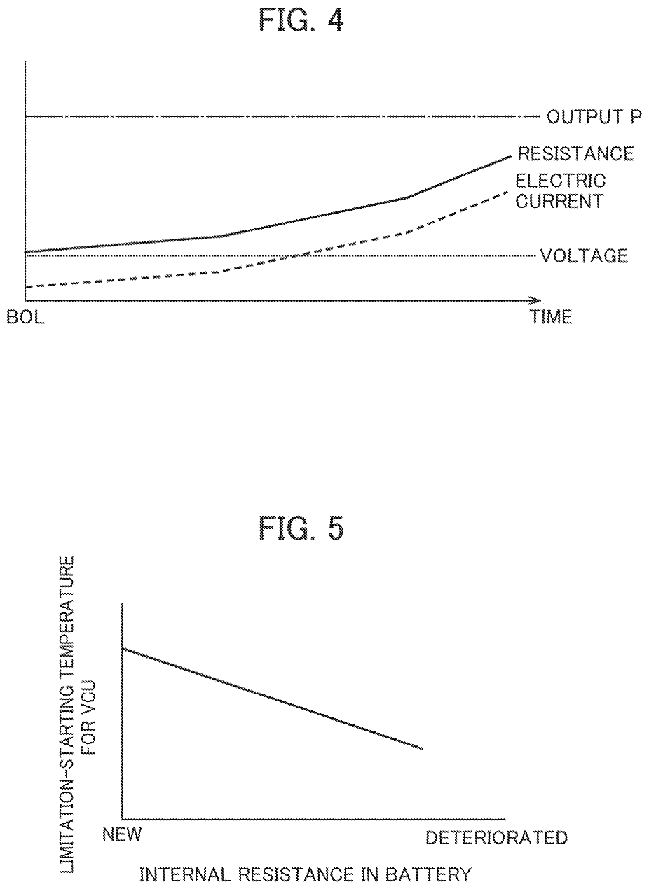

FIG. 4 is a graph illustrating a relationship between resistance and an electric current that change along with deterioration of the battery 11. As illustrated in FIG. 4, internal resistance increases as time passes from the initial state and deterioration advances. Therefore, to achieve a required output after power saving is executed in a state where deterioration of the battery 11 has advanced, it is necessary to allow an electric current to flow at a larger amount than that in the initial state. As an electric current flows at a large amount, a temperature of heat generated in the VCU 13 becomes higher accordingly, making it more difficult to satisfy temperature for allowing the VCU 13 to appropriately function.

Then, as a temperature of the refrigerant (a temperature of the water) that cools the PCU 11 reaches a limitation-starting temperature (a threshold value) that is set, the controller 10 according to the present embodiment performs processing for starting output limitation for the VCU 13. The limitation-starting temperature serving as a trigger for starting of output limitation for the VCU 13 is changed based on a deterioration state of the battery 11. FIG. 5 illustrates an example of this control. FIG. 5 is a graph illustrating a relationship between a deterioration state and a limitation-starting temperature for the VCU, according to the present embodiment.

In the example illustrated in FIG. 5, the limitation-starting temperature in the initial state is set to a predetermined temperature. As illustrated in FIG. 5, the controller 10 executes processing of lowering the limitation-starting temperature for the VCU as time passes from the initial state and deterioration advances.

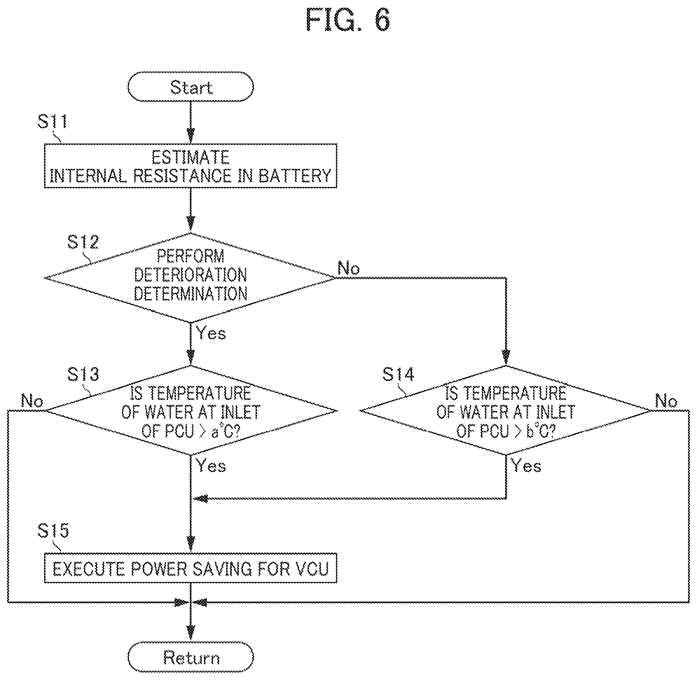

Next, an example of VCU control that the controller 10 performs will now be described herein. FIG. 6 is a flowchart illustrating a flow of processing of first VCU control performed by the controller 10 according to the present embodiment. Note that, in the processing of the first VCU control, which is described below, it is assumed that a relationship of a° C.<b° C. is established between a limitation-starting temperature a and a limitation-starting temperature b.

In step S11, the controller 10 estimates internal resistance of the battery 11. The controller 10 estimates internal resistance based on voltages and electric currents inputted into and outputted from the battery 11, for example. Note that, for voltages and electric currents inputted into and outputted from the battery 11, those detected by the battery sensor 12 may be utilized or those acquired with another method may be utilized. After step S11 in the processing, the processing is caused to proceed to step S12.

In step S12, the controller 10 performs deterioration determination. Deterioration determination is performed based on whether or not internal resistance is higher than a set value σ, for example. The set value σ is a value that is set theoretically or empirically. When an internal resistance value is above the set value σ, the controller 10 causes the processing to proceed to step S13 (step S12; Yes). When the internal resistance value is not above the set value σ, the controller 10 causes the processing to proceed to step S14 (step S12; No).

In step S13, the controller 10 determines whether or not a temperature of the water at the inlet of the PCU is above the limitation-starting temperature a for the VCU 11. When the temperature of the water at the inlet of the PCU is above the limitation-starting temperature a for the VCU 11, the controller 10 causes the processing to proceed to step S15 (step S13; Yes) to execute power saving for the VCU. When the temperature of the water at the inlet of the PCU is not above the limitation-starting temperature a for the VCU 11, the controller 10 causes the processing to return to step S11 (step S13; No) without executing power saving for the VCU.

In step S14, the controller 10 determines whether or not the temperature of the water at the inlet of the PCU is above the limitation-starting temperature b for the VCU 11. When the temperature of the water at the inlet of the PCU is above the limitation-starting temperature b for the VCU 11, the controller 10 causes the processing to proceed to step S15 (step S14; Yes) to execute power saving for the VCU. When the temperature of the water at the inlet of the PCU is not above the limitation-starting temperature b for the VCU 11, the controller 10 causes the processing to return to step S11 (step S14; No) without executing power saving for the VCU.

Since the relationship of a° C.<b° C. has been established, as described above, a lower limitation-starting temperature is set under the first VCU control when there is deterioration, compared with that when there is no deterioration.

Examples of a plurality of types of control that differ from the first VCU control will now be described with reference to the accompanying drawings. Note that, in the below description, descriptions for types of processing common or similar to the processing of the first VCU control may be omitted.

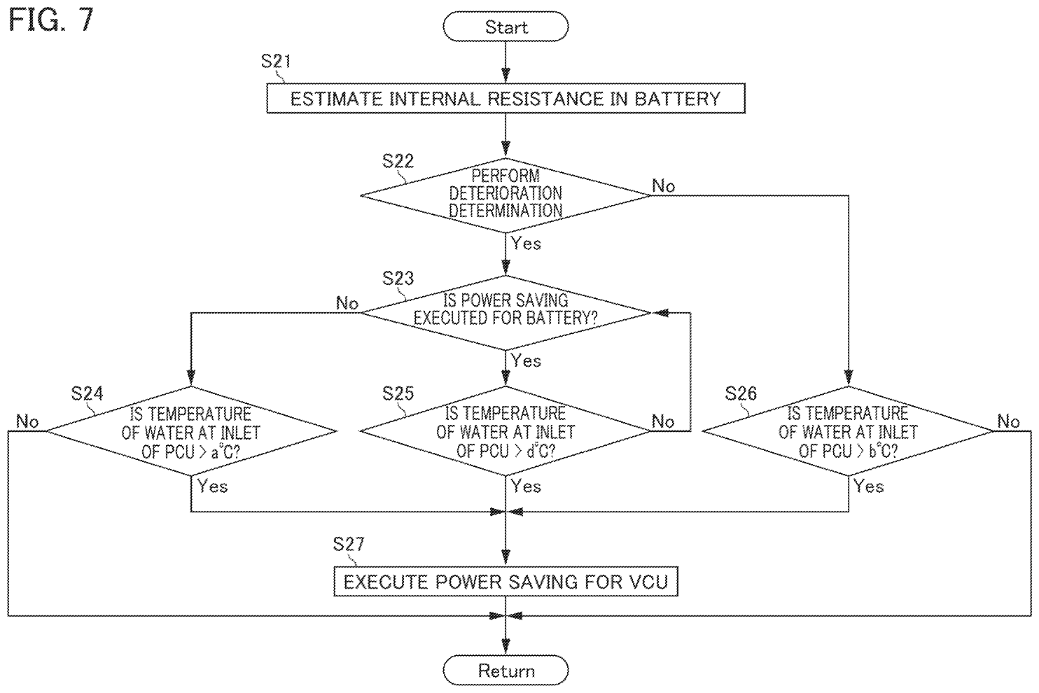

FIG. 7 is a flowchart illustrating a flow of processing of second VCU control performed by the controller 10 according to the present embodiment. Note that, in the processing of the second VCU control, which is described below, it is assumed that a relationship of a° C.<b° C.<d ° C. or a° C.<d° C.<b ° C. is established among a limitation-starting temperature a, a limitation-starting temperature b, and a limitation-starting temperature d.

In step S21, the controller 10 estimates internal resistance of the battery 11. After step S21 in the processing, the controller 10 performs deterioration determination in step S22. The controller 10 causes, when it is determined that there is deterioration, the processing to proceed to step S23 (step S22; Yes), and, when it is determined that there is no deterioration, the processing to proceed to step S26 (step S22; No).

In step S23, the controller 10 determines whether or not power saving has been executed for the battery 11. One reason of performing this determination is, since an output is limited when power saving has been executed for the battery 11, it is not necessary to lower the limitation-starting temperature (the water-temperature threshold value) for the VCU 11 even when the battery 11 is deteriorated. The controller 10 causes, when power saving has not yet been executed for the battery 11, the processing to proceed to step S24 (step S23; No), and, when power saving has been executed for the battery 11, the processing to proceed to step S25 (step S23; Yes).

In step S24, when a temperature of the water at the inlet of the PCU is above the limitation-starting temperature a for the VCU 11, the controller 10 causes the processing to proceed to step S27 (step S24; Yes) to execute power saving for the VCU. When the temperature of the water at the inlet of the PCU is not above the limitation-starting temperature a for the VCU 11, the controller 10 causes the processing to return to step S21 (step S24; No) without executing power saving for the VCU.

In step S25, when the temperature of the water at the inlet of the PCU is above the limitation-starting temperature d for the VCU 11, the controller 10 causes the processing to proceed to step S27 (step S25; Yes) to execute power saving for the VCU. When the temperature of the water at the inlet of the PCU is not above the limitation-starting temperature d for the VCU 11, the controller 10 causes the processing to return to step S23 (step S24; No) to cause the processing to sequentially execute step S23 and later steps.

In step S26, when the temperature of the water at the inlet of the PCU is above the limitation-starting temperature b for the VCU 11, the controller 10 causes the processing to proceed to step S27 (step S26; Yes) to execute power saving for the VCU. When the temperature of the water at the inlet of the PCU is not above the limitation-starting temperature b for the VCU 11, the controller 10 causes the processing to return to step S21 (step S26; No) without executing power saving for the VCU.

Since the relationship of a° C.<b° C.<d ° C. or a ° C.<d ° C.<b° C. has been established, as described above, a lower limitation-starting temperature is set even under the second VCU control when there is deterioration, compared with that when there is no deterioration.

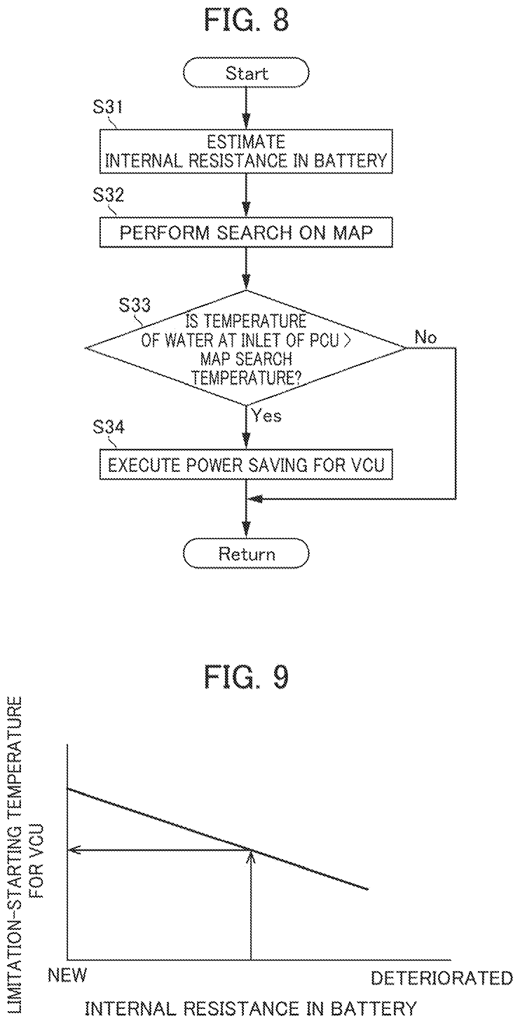

FIG. 8 is a flowchart illustrating a flow of processing of third VCU control performed by the controller 10 according to the present embodiment. FIG. 9 is a graph illustrating an example of a map for determining a limitation-starting temperature for the VCU based on a deterioration state of the third VCU control.

In step S31, the controller 10 estimates internal resistance of the battery 11. After step S31 in the processing, the controller 10 executes a map search in step S32. As illustrated in FIG. 9, the controller 10 is set beforehand with a map for determining a limitation-starting temperature based on internal resistance. As internal resistance is inputted in the map, the controller 10 determines a limitation-starting temperature. In this example, the map is expressed as a mathematical equation according to which, as deterioration advances and internal resistance increases, a limitation-starting temperature is lowered. Note that the present invention is not limited to use a linear straight line illustrated in FIG. 9, but may use another map style. After the limitation-starting temperature is set in step S32 in the processing, the processing proceeds to step S33.

In step S33, when a temperature of the water at the inlet of the PCU is above a map search temperature (a limitation-starting temperature for the VCU 11) determined as a result of the map search performed in step S32, the controller 10 causes the processing to proceed to step S34 (step S33; Yes) to execute power saving for the VCU. When the temperature of the water at the inlet of the PCU is not above the map search temperature in step S33, the controller 10 causes the processing to return to step S31 (step S33; No) without executing power saving for the VCU.

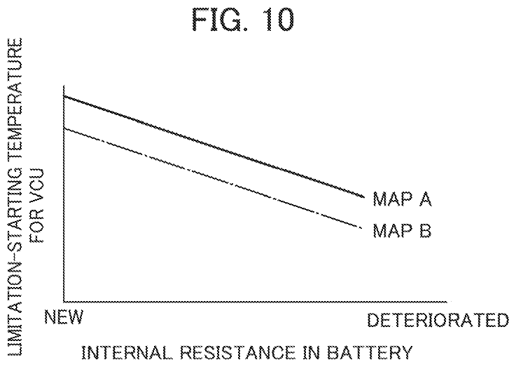

Although the example of determining a limitation-starting temperature based on one map under the third VCU control has been described, the controller 10 may use a plurality of maps for determining a limitation-starting temperature. Fourth VCU control under which a plurality of maps are used will now be described herein. FIG. 10 is a graph illustrating an example of maps for determining a limitation-starting temperature for the VCU based on a deterioration state under the fourth VCU control. As illustrated in FIG. 10, a plurality of maps that are a map A and a map B are used under the fourth VCU control. In this example, the map A and the map B have a relationship where, even when deterioration states are identical to each other, a higher limitation-starting temperature is set when the map A is used than that when the map B is used.

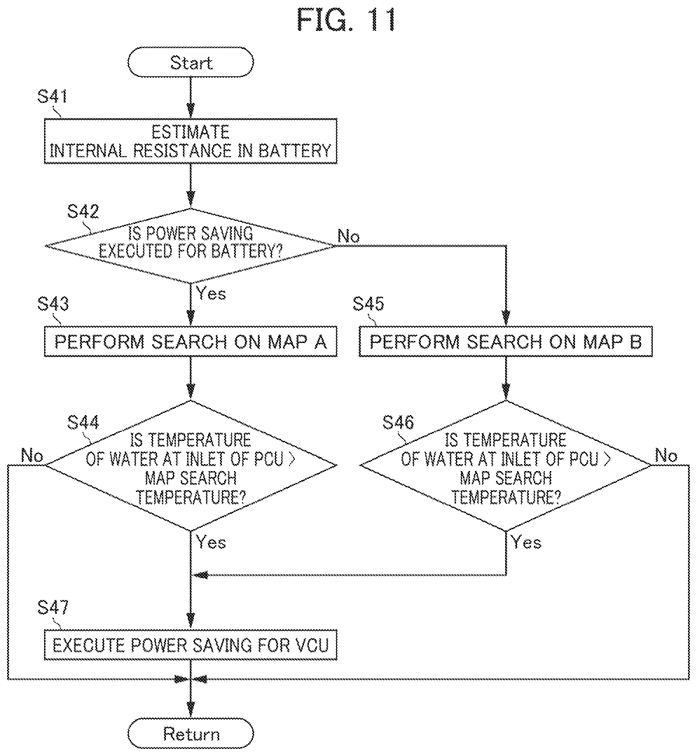

A flow of processing of the fourth VCU control will now be described herein with reference to FIG. 11. FIG. 11 is a flowchart illustrating a flow of processing of the fourth VCU control performed by the controller 10 according to the present embodiment.

In step S41, the controller 10 estimates internal resistance of the battery 11. After step S41 in the processing, the controller 10 causes, in step S42, the processing to proceed to step S43 where the map A is used when power saving has been executed for the battery 11 (step S42; Yes) and the processing to proceed to step S45 where the map B is used when power saving has not yet been performed (step S42; No).

In step S43, the controller 10 performs a search on the map A to determine a limitation-starting temperature. In step S44, when a temperature of the water at the inlet of the PCU is above a map search temperature acquired based on a result of the search on the map A, the controller 10 causes the processing to proceed to step S47 (step S44; Yes) to execute power saving for the VCU. When the temperature of the water at the inlet of the PCU is not above the map search temperature, the controller 10 causes the processing to return to step S41 (step S44; No) without executing power saving for the VCU.

In step S45, the controller 10 performs a search on the map B to determine a limitation-starting temperature. In step S46, when the temperature of the water at the inlet of the PCU is above a map search temperature acquired based on a result of the search on the map B, the controller 10 causes the processing to proceed to step S47 (step S46; Yes) to execute power saving for the VCU. When the temperature of the water at the inlet of the PCU is not above the map search temperature, the controller 10 causes the processing to return to step S41 (step S46; No) without executing power saving for the VCU.

The examples of the types of the VCU control have been described above. The controller 10 executes any one of the first VCU control to the fourth VCU control, for example. The controller 10 may have a configuration where any one of the first VCU control to the fourth VCU control is only executed or a configuration where it is possible to select VCU control to be executed. Note that processing of VCU control is not limited to the examples describe above, but may be appropriately changed.

The controller 10 according to the present embodiment described above executes output limitation in accordance with a temperature of the refrigerant that cools the PCU 14 serving as an electric power converter, and changes a temperature serving as a criterion for executing the output limitation, in accordance with a deterioration state of the battery 11. Thereby, a temperature serving as a criterion for executing output limitation is set in accordance with a deterioration state, allowing the VCU 13 and the PCU 14 to be cooled to an appropriate temperature even when the battery is deteriorated and an electric current flows at a large amount when power saving is executed. Since it is not necessary to prepare a large margin for a power saving threshold value by taking into account a deterioration state, it is possible to avoid an increase in chip size.

Furthermore, as deterioration in the battery 11 advances, the temperature serving as the criterion for executing the output limitation is lowered, in the present embodiment. Thereby, a temperature at which output limitation is executed while reflecting a degree of deterioration is set, making it possible to achieve more appropriate temperature control.

Furthermore, based on whether or not power saving is executed for the battery 11, the temperature serving as the criterion for executing output limitation is lowered, in the present embodiment. Thereby, there is less necessity to execute output limitation on a side of the PCU 14 when power saving is executed for the battery 11 serving as an output supply source, making it possible to achieve more efficient temperature control in accordance with a situation.

Furthermore, a deterioration state of the battery 11 is determined based on internal resistance of the battery 11, in the present embodiment. Thereby, it is possible to accurately set a temperature at which output limitation should be executed, based on internal resistance that may cause to increase an electric current that leads to a problem in temperature.

Furthermore, internal resistance is calculated based on voltages and electric currents inputted into and outputted from the battery 11, in the present embodiment. Thereby, it is possible to calculate internal resistance without adding complicated control or a complicated configuration.

Next, a modification example of VCU control will now be further described herein. Note that, in the below description, like reference numerals designate common or similar components to the components in the embodiment described above, and their detailed descriptions may thus be omitted.

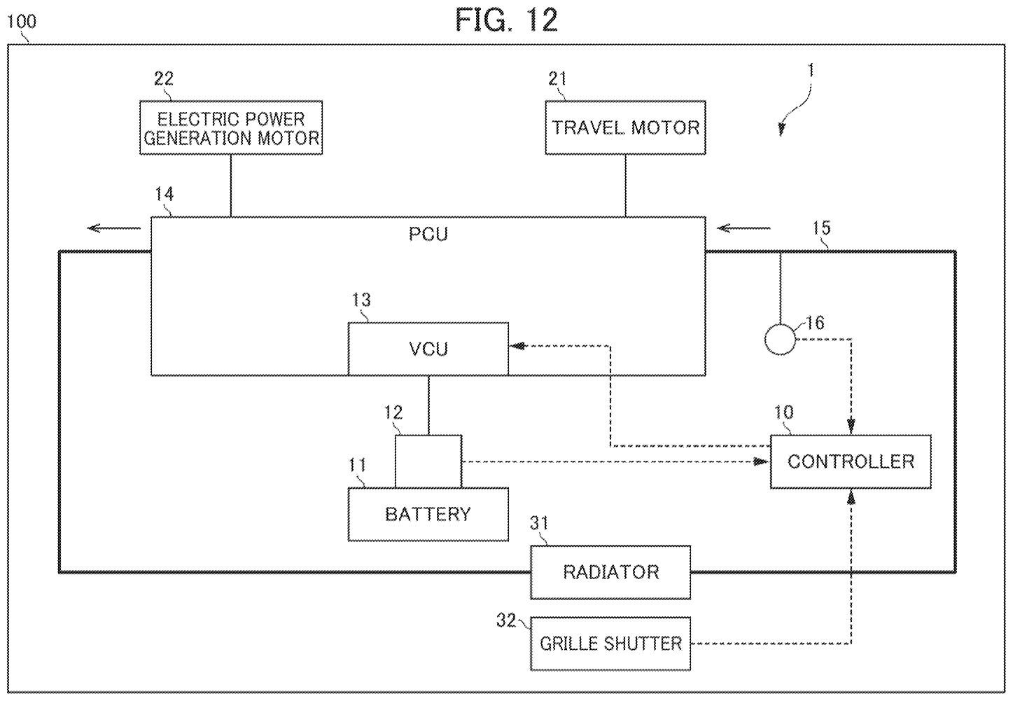

FIG. 12 is a functional block diagram illustrating a configuration of a battery system 1 to which a controller 10 according to the modification example is applied. FIG. 12 illustrates a radiator 31 and a grille shutter 32 mounted on a vehicle 100.

The radiator 31 is disposed in a cooling circuit 15 to serve as a heat exchanger that exchanges heat with a refrigerant. The grille shutter 32 is an active grille shutter (AGS) that opens and closes an air ventilation hole provided on a body of the vehicle 100. The grille shutter 32 may be disposed one or in plural.

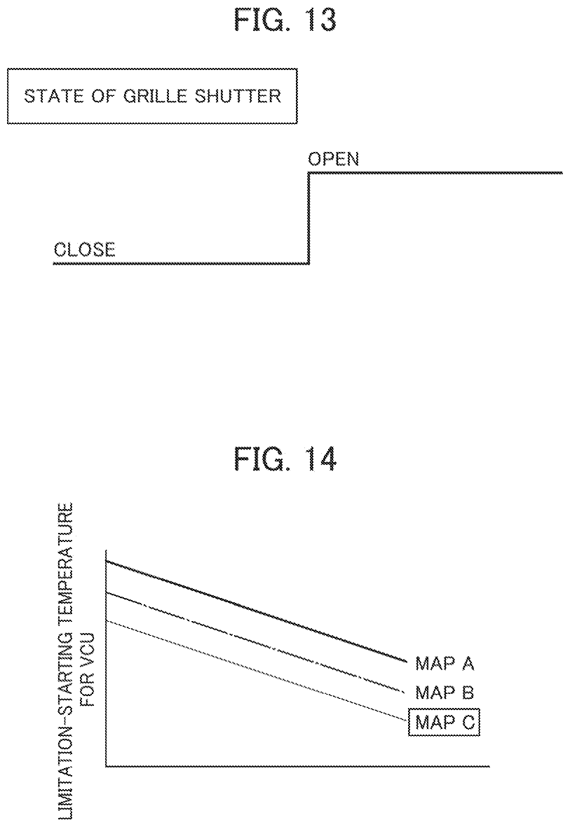

FIG. 13 is a view illustrating an opened state and a closed state of the grille shutter 32. As illustrated in FIG. 13, a louver, for example, makes it possible to switch the grille shutter 32 between the opened state and the closed state. When the grille shutter 32 is in the opened state, air is introduced via the air ventilation hole to cool the radiator 31. When the grille shutter 32 is in the closed state, the air ventilation hole is closed and it is assumed that a temperature of the refrigerant flowing in the cooling circuit 15 increases, compared with that in the case of the opened state.

Then, the controller 10 according to the modification example performs control reflected with transient responsiveness of a temperature of the refrigerant, which changes in accordance with the opened state or the closed state of the grille shutter 32. The controller 10 according to the modification example sets a limitation-starting temperature in such a manner that an amount of limitation is increased when the grille shutter 32 is in the closed state. To set a limitation-starting temperature, it is possible to apply a method in which maps, which are used when the grille shutter 32 is in the closed state, are prepared beforehand, for example.

FIG. 14 is a graph illustrating an example of maps for determining a limitation-starting temperature for the VCU 11 based on a deterioration state, according to the modification example. FIG. 14 illustrates a map A, a map B, and a map C. The map A, the map B, and the map C are maps that differ from each other in limitation-starting temperature even when deterioration states are identical to each other. A relationship between the map A and the map B corresponds to a relationship under which, even when deterioration states are identical to each other, a higher limitation-starting temperature is set when the map A is used than that when the map B is used. A relationship between the map B and the map C corresponds to a relationship under which, even when deterioration states are identical to each other, a higher limitation-starting temperature is set when the map B is used than that when the map C is used. That is, when deterioration states are identical to each other, limitation-starting temperatures follows a relationship of the map A>the map B>the map C.

In the present modification example, the controller 10 selects the map C and identifies a limitation-starting temperature based on a result of a search on the map C when the grille shutter 32 is in the closed state. When the grille shutter 32 is in the opened state, the map A or the map B is used. Thereby, when the grille shutter 32 is in the closed state, a lower limitation-starting temperature is set, compared with that in the case of the opened state. Note that, to select any one of the map A and the map B, the method pertaining to the fourth VCU control described above may be applied, for example.

In the controller 10 according to the modification example described above, a temperature serving as the criterion for executing output limitation is lowered, when the grille shutter 32 mounted on the vehicle 100 is in the closed state, in addition to the configuration according to the embodiment described above. Thereby, it is possible to achieve more accurate temperature control reflected with transient responsiveness of a temperature of the refrigerant, which changes in accordance with the opened state or the closed state of the grille shutter 32.

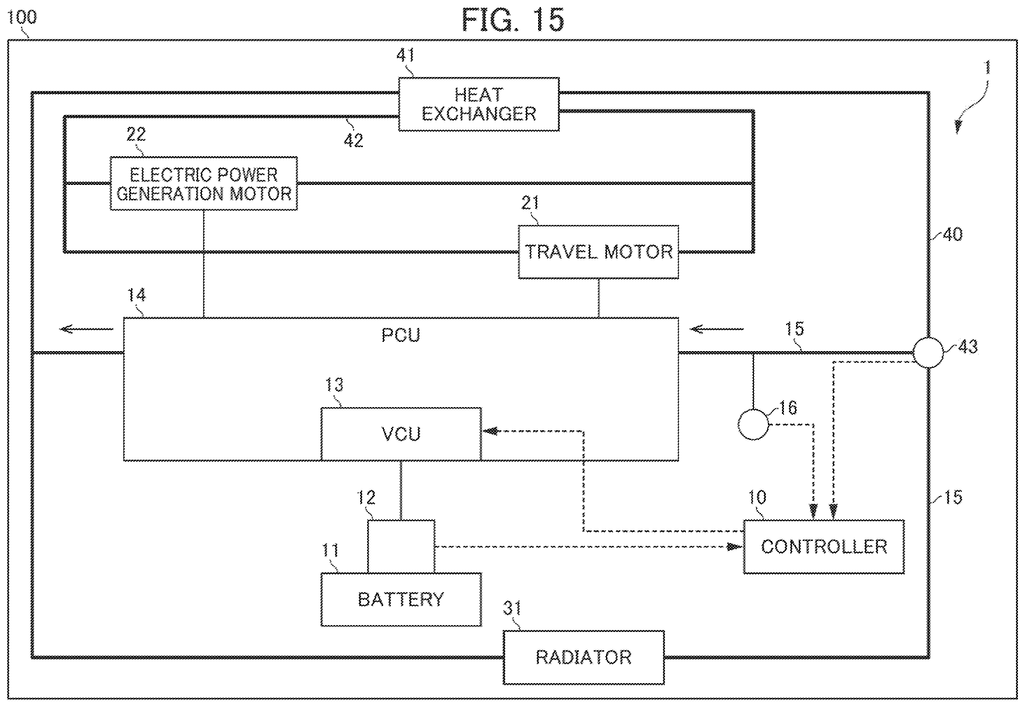

Next, another modification example that takes into account different components than the grille shutter 32 will now be described herein. FIG. 15 is a functional block diagram illustrating a configuration of a battery system 1 to which a controller 10 according to the modification example is applied. FIG. 15 illustrates, in addition to a radiator 31 mounted on a vehicle 100, a second cooling circuit 40 that is branched from a cooling circuit 15.

At a coupling portion between the cooling circuit 15 and the second cooling circuit 40, a flow shut-off valve (FSV) 43 is disposed. The flow shut-off valve 43 is, for example, an always-open (normally-open) type electromagnetic valve that couples the cooling circuit 15 and the second cooling circuit 40 to each other when no electric power is supplied and closes the second cooling circuit 40 with respect to the cooling circuit 15 when electric power is supplied.

The second cooling circuit 40 is disposed with a heat exchanger 41. The heat exchanger 41 is coupled to the second cooling circuit 40 and further coupled to an automatic transmission fluid (ATF) circuit 42 that exchanges heat with a device on a drive side. In the ATF circuit 42, an automatic transmission fluid (ATF) circulates as a medium. The ATF circuit 42 is disposed with a travel motor 21 serving as a driver that provides a driving force to the vehicle 100 and an electric power generation motor 22, and the travel motor 21 and the electric power generation motor 22 are adjusted in temperature by the ATF.

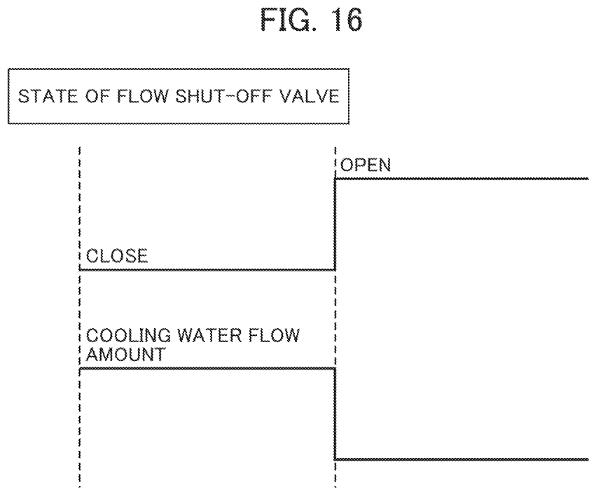

FIG. 16 is a view illustrating a relationship between an opened state and a closed state of the flow shut-off valve 43 and an amount of cooling water. FIG. 16 illustrates the relationship between an amount of the cooling water flowing in the cooling circuit 15 when the flow shut-off valve 43 is in the closed state and an amount of the cooling water flowing in the cooling circuit 15 when the flow shut-off valve 43 is in the opened state. In the opened state, the cooling circuit 15 and the second cooling circuit 40 are coupled to each other, and heat is exchanged with not only the PCU 14, but also the heat exchanger 41. Since, in the closed state, on the other hand, the second cooling circuit 40 is closed with respect to the cooling circuit 15, the refrigerant flows into the cooling circuit 15, but does not flow into the second cooling circuit 40. Therefore, when the flow shut-off valve 43 is in the opened state, heat is exchanged with the heat exchanger 41, and it is assumed that a temperature of the refrigerant rises and a flow amount of the refrigerant lowers, compared with those in the case of the closed state.

Then, the controller 10 according to the modification example performs control reflected with fluctuation in temperature of the water, in accordance with the opened state or the closed state of the flow shut-off valve 43. Since heat is exchanged with the heat exchanger 41 when the flow shut-off valve 43 is in the opened state, the controller 10 according to the modification example sets a limitation-starting temperature in such a manner that an amount of limitation is increased. To set a limitation-starting temperature, it is possible to apply a method in which a map is used, as described with reference to FIG. 14, for example.

When the flow shut-off valve 43 is in the opened state, the controller 10 selects the map C and identifies a limitation-starting temperature based on a result of a search on the map C. When the flow shut-off valve 43 is in the closed state, the map A or the map B is used. Thereby, when the flow shut-off valve 43 is in the opened state, a lower limitation-starting temperature is set, compared with that in the case of the closed state. Note that, to select any one of the map A and the map B, the method pertaining to the fourth VCU control described above may be applied, for example.

In the controller 10 according to the modification example describe, the second cooling circuit 40 into which the refrigerant for the PCU 14 flows is disposed with the heat exchanger 41 that causes heat to be exchanged with the refrigerant for the travel motor 21 serving as a driver and the electric power generation motor 22, in addition to the components according to the embodiment described above, and, while heat is exchanged by the heat exchanger 41, a temperature serving as the criterion for executing output limitation is lowered. Thereby, it is possible to achieve more accurate temperature control reflected with a change in temperature of the refrigerant, which fluctuates depending on whether or not heat is exchanged with the heat exchanger 41.

Although embodiments and modification examples of the present invention have been described above, the present invention is not limited to the embodiment and the modification examples described above. Furthermore, the advantageous effects described in embodiments and modification examples of the present invention correspond to preferable effects merely listed, and effects of the present invention are not limited to those described in the embodiment and the modification examples.

### EXPLANATION OF REFERENCE NUMERALS

10 Controller
11 Battery
13 VCU
14 PCU
15 Cooling circuit
32 Grille shutter
40 Cooling circuit
41 Heat exchanger
43 Flow shut-off valve

What is claimed is:

1. A controller that executes output limitation in accordance with a temperature of a refrigerant that cools an electric power converter, and
changes a temperature serving as a criterion for executing the output limitation, in accordance with a deterioration state of a battery.

2. The controller according to claim 1, wherein, as deterioration in the battery advances, the temperature serving as the criterion for executing the output limitation is lowered.

3. The controller according to claim 1, wherein, based on whether or not power saving is executed for the battery, the temperature serving as the criterion for executing the output limitation is lowered.

4. The controller according to claim 1, wherein the deterioration state of the battery is determined based on internal resistance of the battery.

5. The controller according to claim 4, wherein the internal resistance is calculated based on voltages and electric currents inputted into and outputted from the battery.

6. The controller according to claim 1, wherein, when a grille shutter mounted on a vehicle is in a closed state, the temperature serving as the criterion for executing the output limitation is lowered.

7. The controller according to claim 1, wherein,
a heat exchanger that exchanges heat with a refrigerant for a driver is disposed in a cooling circuit, in which the refrigerant flows, for the electric power converter, and
while heat is exchanged by the heat exchanger, the temperature serving as the criterion for executing the output limitation is lowered.
